(19) United States
(12) Patent Application Publication
(10) Pub. No.: US 2009/0157688 A1
(43) Pub. Date: Jun. 18, 2009

(54) USAGE HISTORY BASED CONTENT EXCHANGE BETWEEN A BASE SYSTEM AND A MOBILE SYSTEM

(75) Inventors: Bartel Marinus Van De Sluis, Eindhoven (NL); Elmo Marcus Attila Diederiks, Eindhoven (NL); Mark Henricus Verberkt, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/719,663

(22) PCT Filed: Nov. 21, 2005
(86) PCT No.: PCT/IB2005/053844

§ 371 Date: May 18, 2007

Related U.S. Application Data
(60) Provisional application No. 60/630,703, filed on Nov. 24, 2004.

(51) Int. Cl. G06F 17/30

(52) U.S. Cl. 707/10; 707/E17.01

(57) ABSTRACT

A method and system for transferring information from a base system (110) to a mobile system (120) based on a history of usage of information at the base system (110). Recently used files at the base system (110) are transferred to the mobile system (120), without express user interaction. Select files or directories may be marked as ‘never download’, but absent this designation, any file on the base system (110) is a potential candidate for downloading to a mobile system (120). Rules are established to prioritize (220) download candidates, as well as to determine how much (240) of the candidate information to download. In a preferred embodiment, the downloading occurs on a continuing basis (315-335), so that an explicit download command need not be executed. This downloading is configured to occur in a non-interfering manner with explicit download systems and methods (340-360). Security schemes may also be included to avoid security breaches associated with an automated download.

This invention relates to the field of computer systems, and in particular to a method and system for downloading content material from a base system to a mobile system, based on a history of usage of the content material.

A variety of methods and systems are available for downloading material from a base system, such as an office or home computer, to a mobile system, such as a laptop computer, a personal digital assistant (PDA), and so on. The term ‘synchronization’ is often used to describe the process of copying information from a base system to a mobile system.

Most of these methods and systems include a user interface that allows a user to identify files that should be synchronized, files available for sharing, and so on. Typically, the user sets up a default set of options, including the identification of files or directories that should be copied when the user activates the ‘synchronize’ command. When the user desires to download the shared files, the user activates the synchronize command, and the identified files and directories are downloaded from the base system to the mobile system, so that the user has access to these files when the user is remote from the base system.

It often happens, however, that when the user is remote from the base system, the user discovers that he or she does not have access to a desired file. The user may have worked on a file in a different context than the user's routine activities, and the file was not placed in a shared folder. Similarly, the desired information may have been information on a particular web-page that would be easy to access on the user's base system via a “history” tab on a conventional web-browsers, but difficult to access on the mobile system unless the user recalls the sequence of browsing activities that lead to the particular page, because the “history” of web access via the mobile system does not contain this web-page. In other cases, the user may have forgotten, or did not have time, to activate the synchronize command.

It is an object of this invention to increase the likelihood that desired information from a base system is available on a mobile system. It is a further object of this invention to reduce the need for user interaction to effect a transfer of information to a mobile system.

These objects, and others, are achieved by a method and system that transfers information from a base system to a mobile system based on a history of usage of information at the base system. Recently used files at the base system are transferred to the mobile system, substantially regardless of the location of the information at the base system. Select files or directories may be marked as ‘never download’, but absent this designation, any file on the base system is a potential candidate for downloading to a mobile system. Rules are established to prioritize download candidates, as well as to determine how much of the candidate information to download. In a preferred embodiment, the downloading occurs on a continuing basis, so that an explicit download command need not be executed. This downloading is configured to occur in a non-interfering manner with explicit download systems and methods. Security schemes may also be included to avoid security breaches associated with an automated download.

The invention is explained in further detail, and by way of example, with reference to the accompanying drawings wherein:

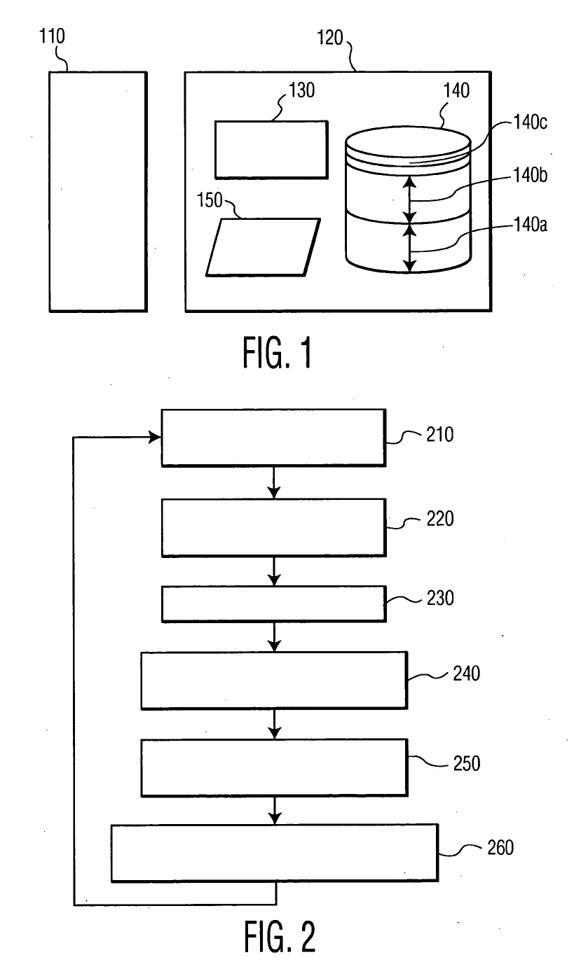

FIG. 1 illustrates an example block diagram of a downloading system in accordance with this invention.

FIG. 2 illustrates an example flow diagram of a downloading system in accordance with this invention.

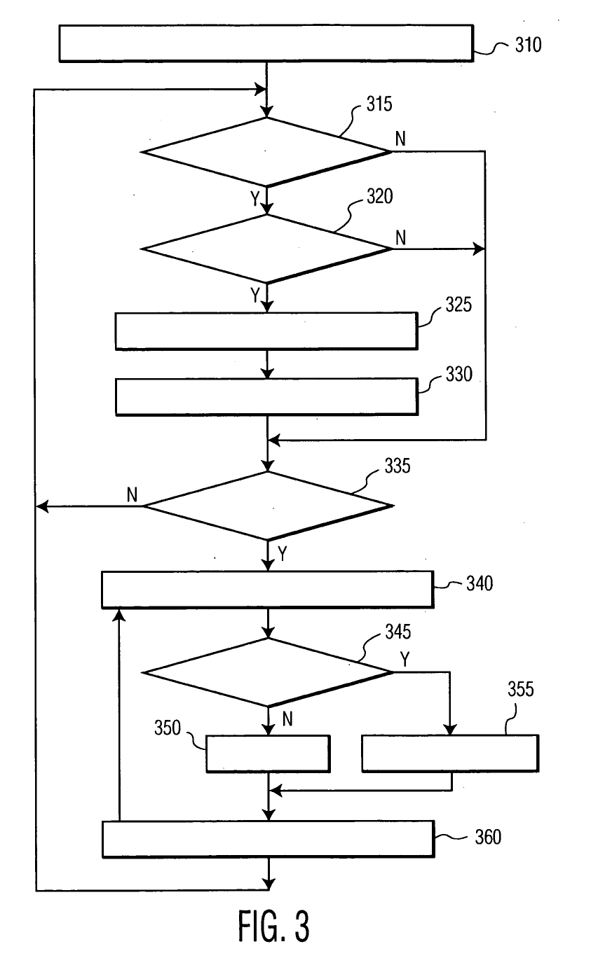

FIG. 3 illustrates another example flow diagram of a downloading system in accordance with this invention.

Throughout the drawings, the same reference numeral refers to the same element, or an element that performs substantially the same function. The drawings are included for illustrative purposes and are not intended to limit the scope of the invention.

FIG. 1 illustrates an example block diagram of a downloading system in accordance with this invention. A mobile system 120 includes a memory 140, and a controller 130 that controls the transfer of data to and from the memory 140. The memory 140 is illustrated as including two segments 140a and 140b. The segment 140a includes the memory that is allocated to store information that has been expressly stored, such as files that a user has expressly transferred from a base system 110, files that facilitate operation of the mobile system 120, and so on. For ease of reference, the term “file” is used herein to define any set of information or data. The segment 140b is herein defined as available “spare” memory, and may include, as discussed below, files that are dynamically stored without requiring user intervention. Note also that the ‘partitioning’ of the memory 140 into segments 140a, 140b, is illustrated for ease of understanding. One of ordinary skill in the art will recognize that the partitioning may be ‘logical’, rather than ‘physical’. For example, each sector of memory may have an associated status that indicates whether the sector is allocated to a file that has been expressly stored, allocated to a file that has been dynamically stored using the principles of this invention, or as yet unallocated. In this example, the spare memory 140b would comprise the sectors that have been dynamically stored, and perhaps some or all of the as-yet-unallocated sectors.

FIG. 1 illustrates a base system 110, which represents one or more systems that include files that are available for downloading to the mobile system 120. The term base system is used for ease of understanding; one of ordinary skill in the art will recognize that the base system 110 may include other mobile systems as well.

The system of FIG. 1 is best understood with reference to the operation of the controller 130, as illustrated by the example flow diagram of FIG. 2.

At 210, files at the base system 110 are evaluated to determine their relative ‘priority’ for transfer to the mobile system 120. In accordance with this invention, this priority is based on user defined criteria and/or default system criteria. The default system criteria includes measures such as the most recent time that activities related to the file occurred, the most recent time that the file was updated, the type of file, and so on. This invention is based on the premise that, if a user requires a file from the base system 110 that was not expressly downloaded to the mobile system 120, it is likely that the user may have recently accessed the file on the base system 110, or that the file recently arrived at the base system 110, and so on. Further, depending upon the particular user, the likelihood that the user may require the file is also dependent upon the type of file. For example, if the user uses the mobile system 120 primarily for working while away from the base system 110, it is likely that the required file will be a “.doc” file, a “.pdf” file, and so on. Similarly, a particular user's projected need for a file may be based on an identification of the creator of the file, the age of the file, the availability of the file from other sources, and so on. In like manner, e-mail files, project-related files, news messages, and so on, that have not yet been read, may be given a high priority for transfer to the mobile system. In some contexts, such as the reading of ‘junk’ e-mail, files that have recently been accessed may have a very low priority for transfer to the mobile system.

Note that although the controller 130 of FIG. 1 is illustrated as being located within the mobile system 120, the base system 110 may also be configured to facilitate the determination of priority of files on the base system 110. For example, the base system 110 may be configured to automatically notify the mobile system 120 whenever a file on the base system 110 is accessed and/or whenever a file is saved at the base system 110.

At 220, the priority of the files at the spare memory 140b of the mobile system 120 is also determined. To facilitate this determination, a database 150 of prior determined priorities of the data currently stored in the available spare memory 140b is optionally maintained. Preferably, this priority is based on the same criteria that is used to determine the priority of the files at the base system 110, but attenuated by whether the file is already downloaded to the memory 140a.

At 230, the priorities of the files at the base system 110 and the mobile system 120 are merged/interleaved to determine a composite list of priority-ordered files. Optionally, it can be assumed that the priority of the files at the available spare memory 140b on the mobile system 120 is irrelevant relative to the files at the base system 110, and blocks 220-230-230 can be avoided.

At 240, the amount of available spare memory 140b at the mobile system 120 is determined. Preferably, this available spare memory is defined as the total memory 140 of the mobile system 120 minus the expressly allocated memory 140a, minus a defined amount of memory 140c that is set aside for normal operation of the mobile system 120.

Based on the available spare memory, the interleaved list of files at the base system 110 and mobile system 120 is assessed to determine the files that should be allocated to the available spare memory 140b. At 250, files at the mobile system 120 that are not allocated to be retained in the spare memory 140b are deleted from the memory 140b. At 260, files at the base system 110 that are allocated to be stored in the spare memory 140b are copied from the base system 110 to the spare memory 140b. As noted above, if, at 220, the files that were previously at the spare memory 140b are automatically considered to be of lower priority than files at the base system 110, then block 240 can be avoided, and block 250 is configured to delete all of the current files from the spare memory 140b, thereby maximizing the available spare memory 140b for storing files from the base system 110.

In a preferred embodiment of this invention, the user may configure the controller 130 to save the files in the spare memory 140b in a secure manner, to prevent unauthorized access to files that are “unknowingly” transferred to the mobile system.

One of ordinary skill in the art will recognize that the aforementioned deletion of files from the spare memory 140b can be a ‘logical’ deletion, wherein the sectors of memory used to store the files that are being deleted are merely marked as being ‘free’ for overwriting with new information, using, for example, the aforementioned sector-status information associated with the sectors containing the file.

One of ordinary skill in the art will also recognize that additional limits may be placed on the determination of available spare memory, such as a predetermined maximum size of the spare memory 140b. In like manner, a limit can be set on establishing a priority for files on the base system 110. For example, once the priority falls below a given value, the priority may be set to zero, indicating that the file should not be copied to the mobile system 120, regardless of the amount of available spare memory 140b. In like manner, a maximum time interval may be defined, wherein files that have not been accessed within that time interval should not be copied, regardless of the available spare memory 140b, and regardless of other priority factors.

FIG. 3 illustrates an example flow diagram of another embodiment of this invention, as may be used in a controller 130 of FIG. 1. In this example embodiment, files that are saved at the base system are automatically considered for also saving at the mobile system. One of ordinary skill in the art will recognize that other types of file activities, in addition to a “save” operation, may also be used to trigger this automatic consideration. One of ordinary skill in the art will also recognize that a “save” operation may include both express saves and transparent saves, such as automatic/periodic saves of files that are being created or edited, saves of newly received material, such as e-mails and messages, and so on.

Block 310 represents an initial synchronization of the base system and the mobile system, as may occur when communications are first established between the mobile system and the base system. Optionally, this block can be omitted, if it is assumed that the user will expressly invoke a synchronization command if synchronization is desired.

At block 315, the controller determines whether a save operation has occurred at the base system. As noted above, preferably the base system is configured to notify the mobile system whenever a file is saved at the base system. Alternatively, the mobile system may periodically query the base system for any recent change of status of files on the base system. If no files have recently been saved at the base system, the process continues at 335, discussed below.

If, at 315, it is determined that a file was recently stored at the base, the controller determines whether the file is a storable file, at 320, based on a priority determined by user defined criteria and/or default criteria. The term priority as used herein may be a simple binary yes/no determination, or it may be a quantitative or comparative measure. For example, the default priority may be to store all text and graphic files, but not “system” files. In like manner, the user may specify a low priority for storing files at the mobile system above a given size. If the priority for storing the file indicates that the file should not be stored on the mobile system, the process continues at 335, discussed below.

If, at 320, it is determined that the priority of the file warrants storage on the mobile system, space is created in the spare memory, at 325, for storing this file, at 330. Assuming that files already exist in the spare memory, this space is created by deleting one or more files currently in the spare memory. The choice of which file or files to delete can be based on a determination of the priority of each file, as in the embodiment of FIG. 2, or a simple first-in first-out (FIFO) strategy may be used, wherein the oldest file in the spare memory is deemed to be of lower priority than the newest file, and is therefore deleted to make room for the newest file. Different FIFO queues may be maintained for different types of files, so that, for example, text files replace text files, graphic files replace graphic files, and so on. In like manner, different priority determinations and comparisons can be provided for different types of files, different authors of files, and so on.

At 335, the controller determines whether an expressed synchronization has been requested, either directly by the user, or in accordance with a predefined schedule. If not, the controller loops back to 315 to continue monitoring for files that are saved at the base system, and the above process is repeated.

Generally, a conventional synchronization process identifies any files that have changed since the last time a synchronization was performed. If, at 335, an express synchronization is requested, each of these identified changed files is further processed in the loop 340-360.

At 345, a determination is made as to whether the file has already been copied into the spare memory of the mobile system; if not, the file is copied to the mobile system, at 350. This determination includes checking the date-time stamp associated with the file, to assure that the latest version of the file is located in the spare memory. This will generally be the case, because each time the file was saved at the base system, the process at 315-330 will have been invoked to copy the file to the mobile system, as detailed above.

If, at 345, the file is determined to already be in the spare memory of the mobile system, the memory is reallocated within the mobile system to identify the file as being an expressly saved file. Preferably, this is accomplished by changing the aforementioned status of the sectors of the memory from dynamically-saved to expressly-saved. Alternatively, if a sector-status is not used to partition the memory, and a physical partitioning is used, the file is appropriately relocated within the memory of the mobile system.

As in a conventional file-copy or file-save operation, if the mobile system contains an older version of the expressly saved file, having, for example the same name but an older date-time stamp, that older file is deleted to provide space within the expressly-saved partition of the memory for storing the newer version as an expressly-saved file.

After all of the changed expressly saved files are processed, the controller loops back to 315 to continue monitoring for files that are saved at the base system, and the above process is repeated.

One of ordinary skill in the art will recognize that the loop 315-360 may be programmed to occur at scheduled time intervals, rather than continuously as illustrated in FIG. 3, to reduce the processing time at the mobile system. In like manner, the loop 315-360 may be invoked only when the base system reports a noticeable event, wherein a noticeable event includes a save operation or synchronization request at the host system. In such an embodiment, the loop 340-360 will also be invoked whenever a synchronization request is initiated at the mobile system.

Note that by using the process 315-330 of FIG. 3, it is likely that all updates to files on the base system that are storable to the mobile system will be dynamically saved to the mobile system, without user interaction. In the event that the user forgets to expressly synchronize the mobile system with the base system, or in the event that the user does not have the time to expressly synchronize the mobile system with the base system, the mobile system is likely to contain a copy of files that might become necessary to access after the mobile system is removed from communication with the base system.

The mobile system may be configured to allow the user to access dynamically-saved files in the same manner as expressly-saved files, without distinction. Or, the mobile system may be configured to provide a list of current dynamically-saved files, upon request, and allow the user to access files from this list. The method of access to these files may also be dependent upon the type of file. For example, if the copied file is a transferred ‘history’ file from a web-browser on the base system, the system may be configured to present the information outside the context of a web-browser on the mobile system, to avoid a conflict of histories. Alternatively, the copied history file from the base system may be merged with the history file of the web-browser on the mobile system, to present a consolidated view of the user's activities at both the base system and the mobile system. These and other options for allowing the use of the dynamically-saved files at the mobile system will be evident to one of ordinary skill in the art in view of this disclosure.

The foregoing merely illustrates the principles of the invention. It will thus be appreciated that those skilled in the art will be able to devise various arrangements which, although not explicitly described or shown herein, embody the principles of the invention and are thus within its spirit and scope. For example, the controller 130 and/or the priority list 150 may be located at the base system 110, rather than in the mobile system 120, or the function of the controller 130 and priority list 150 may be shared between the base system 110 and the mobile system 120. In like manner, although the principles of this invention are particularly well suited for providing files to a mobile system, the principles of this invention are not limited to mobile systems, and can be used, for example, to transfer files among multiple base systems. These and other system configuration and optimization features will be evident to one of ordinary skill in the art in view of this disclosure, and are included within the scope of the following claims.

In interpreting these claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) each of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise;

h) no specific sequence of acts is intended to be required unless specifically indicated; and

i) the term “plurality of” an element includes two or more of the claimed element, and does not imply any particular range of number of elements; that is, a plurality of elements can be as few as two elements.

1. A method of transferring information between a first system (110) and a second system (120), comprising:
detecting (315) activity related to a file at the first system (110),
determining (320) a priority for storing the file at the second system (120), and
copying (330) the file from the first system (110) to the second system (120) based on the priority.

2. The method of claim 1, wherein
the priority is based on a time of the activity related to the file at the first system (110).

3. The method of claim 1, wherein
the priority is based on a type of activity related to the file at the first system (110).

4. The method of claim 1, wherein
the priority is based on a type of the file at the first system (110).

5. The method of claim 1, wherein
the first system (110) is a substantially fixed-location system, and
the second system (120) is a mobile system.

6. The method of claim 1, wherein
copying (330) the file to the second system (120) is further based on an amount of spare memory (140b) available at the second system (120).

7. The method of claim 6, further including
deleting (325) one or more other files at the second system (120) to increase the amount of spare memory (140b) available at the second system (120).

8. A method of selecting files for copying from a first system (110) to a second system (120), comprising:
identifying one or more files at the first system (110),
determining (210, 320) a priority corresponding to each of the one or more files, and
selecting (230, 320) the files for copying from the first system (110) to the second system (120) based on the priority of each of the one or more files at the first system (110).

9. The method of claim 8, further including:
copying (260, 330) the files selected for copying from the first system (110) to the second system (120).

10. The method of claim 9, further including:
identifying (340) a set of files at the first system (110) for expressly copying to the second system (120), and
for each file of the set of files,
changing (355) a status of the file if (345) the file has been copied from the first system (110) to the second system (120), and
copying (350) the file from the first system (110) to the second system (120) if (345) the file has not been copied from the first system (110) to the second system (120).

11. The method of claim 8, further including:
determining (220) a priority corresponding to each of one or more files at the second system (120),
wherein
selecting the files for copying from the first system (110) to the second system (120) is further based (230) on the priority of each of the one or more files at the second system (120).

12. The method of claim 8, wherein
the priority of each of the one or more files at the first system (110) is based on a time of activity related to each of the one or more files at the first system (110).

13. The method of claim 12, wherein
the priority of each of the one or more files at the first system (110) is further based on at least one of:
a type of the file,
a frequency of access to the file,
an author of the file,
a type of the activity related to the file, and
an age of the file.

14. The method of claim 8, further including
receiving selection criteria from a user, and
wherein
determining the priority is based on the selection criteria.

15. The method of claim 8, wherein
the first system (110) is a substantially fixed-location system, and
the second system (120) is a mobile system.

16. A system (120) comprising:
a memory (140), and
a controller (130), operably coupled to the memory (140), that is configured to automatically copy select files from an other system (110) to the memory (140),
wherein
the controller (130) is configured to:
determine a priority associated with each of a plurality of files at the other system (110), and
select the select files from the plurality of files based on the priority associated with each of the plurality of files.

17. The system (120) of claim 16, wherein
the controller (130) is further configured to determine an amount of spare memory space (140b) in the memory (140), and selects the select files based further on the amount of spare memory space (140b).

18. The system (120) of claim 16, wherein
the controller (130) determines the priority associated with each of the plurality of files based on a time of activity related to each of the plurality of files.

19. The system (120) of claim 16, wherein
the controller (130) determines the priority associated with each of the plurality of files based on at least one of:
a type of each file,
a frequency of access to each file,
an author of each file,
a type of the activity related to each file, and
an age of each file.

20. The system (120) of claim 16, wherein
the system (120) is a mobile system, and
the other system (110) is a relatively fixed-location system.

21. A system (110) comprising:
a memory (140), and
a controller (130), operably coupled to the memory (140), that is configured to automatically copy select files from the memory (140) to an other system (120),
wherein
the controller (130) is configured to:
determine a priority associated with each of a plurality of files in the memory (140), and
select the select files from the plurality of files based on the priority associated with each of the plurality of files.

22. The system (110) of claim 21, wherein
the controller (130) is further configured to determine an amount of spare memory space (140b) at the other system (120), and selects the select files based further on the amount of spare memory space (140b).

23. The system (110) of claim 21, wherein
the controller (130) determines the priority associated with each of the plurality of files based on a time of activity related to each of the plurality of files.

24. The system (110) of claim 21, wherein
the controller (130) determines the priority associated with each of the plurality of files based on at least one of:
a type of each file,
a frequency of access to each file,
an author of each file,
a type of the activity related to each file, and
an age of each file.

25. The system (110) of claim 21, wherein
the system (110) is a relatively fixed-location system, and
the other system (120) is a mobile system.
